(19) United States
(12) Patent Application Publication
(10) Pub. No.: US 2003/0045606 A1
(43) Pub. Date: Mar. 6, 2003

(54) Friction material using aramide resin dust

(75) Inventors: Satoshi Kusaka, Saitama (JP); Yosuke Sasaki, Saitama (JP)

Correspondence Address: Finnegan, Henderson, Farabow,, Garrett & Dunner, L.L.P., 1300 I Street, N.W., Washington, DC, 20005-3315, US

(73) Assignee: AKEBONO BRAKE INDUSTRY CO., LTD.

(21) Appl. No.: 10/108,385

(22) Filed: Mar. 29, 2002

(30) Foreign Application Priority Data
Mar. 30, 2001 (JP) 2001-100582

(51) Int. Cl. C08J 5/14

(52) U.S. Cl. 523/149

(57) ABSTRACT

The invention provides a friction material containing a fibrous reinforcement, a friction modifier, and a binder as major components, which does not contain asbestos fibers but contains, as an organic friction modifier, para-, meta- and meta-para-type aramide resin dusts independently or as a mixture thereof. It is preferred to mix the para-type and m-type aramide resin dusts independently or as a mixture in an amount of 1 to 60% by volume based on the volume of the whole friction material.

### BACKGROUND OF THE INVENTION

1. Field of the Invention

The present invention relates to a friction material, more particularly, to a friction material for use in industrial machines, railroad vehicles, baggage vehicles, passenger cars, etc. More specifically, it relates to a brake pad, brake lining, clutch facing, etc. for the above-described uses.

2. Description of the Related Art

A friction material to be used for brakes such as a disc brake and a drum brake, or for a clutch comprises a friction modifier which imparts a frictional action and modifies its frictional performance, a fibrous medium which exhibits a reinforcing action, a binder which functions to bind these substances and impart strength, and the like.

The fibrous medium among the substances includes metal fibers, inorganic fibers, organic fibers, etc. and, since one kind thereof is insufficient to meet all requirements, two or more kinds of them are commonly used in combination. Japanese Patent Laid-Open Hei 1-33699 discloses that meta-type, meta-para-type aramide fibers or pulps serve to improve wear resistance of a friction material in the temperature range wherein a brake is ordinarily used.

On the other hand, as a material for modifying frictional properties of a friction material, there are a friction modifier and a solid lubricant. There are also inorganic and organic friction modifiers and solid lubricants and, since one kind thereof fails to meet all requirements, two or more kinds of them are commonly used in combination.

As the friction modifiers, there may be illustrated inorganic friction modifiers such as alumina, silica, magnesia, zirconia, chromium oxide and quarts, and organic friction modifiers such as synthetic rubbers and cashew resin and, as the solid lubricants, there may be illustrated, for example, graphite and molybdenum disulfide.

In conventional friction materials for a brake, there have been used cashew dust and the like as organic friction modifiers. The organic friction modifiers such as cashew dust liquefy at a temperature of an opposite member of from about 200 to about 250° C. and exhibits a lubricating action, thus serving to prevent wear of the friction material and the opposite member, stabilize a coefficient of friction and prevent noise.

Main properties required for a friction material essentially for braking use are stable frictional properties, heat resistance, wear resistance, etc. Of these required properties, frictional properties have reached an almost satisfactory level in the conventional art, with friction materials using a fibrous medium showing a particularly good performance. However, it has eagerly been desired to secure frictional properties at an elevated temperature up to a higher temperature range and improve wear resistance.

### SUMMARY OF THE INVENTION

A subject of the invention is to provide a friction material which shows a stable frictional performance and a wear resistance up to a higher temperature range by using an organic friction modifier having an excellent heat resistance to utilize its excellent heat resistance.

That is, the subject of the invention is to provide a friction material having frictional properties, heat resistance and wear resistance at an elevated temperature.

With the above problem in mind, the inventors have made various investigations for an organic dust which exhibits a lubricating effect at a higher temperature range than with the conventional cashew dust, i.e., at a temperature range of from 250 to 450° C.

As a result, the inventors have noted that prevention of wear, prevention of noize, stabilization of the coefficient of friction of a friction material and prevention of noize, and an opposite member in a higher temperature range than that with the conventional organic friction materials such as cashew dust having a thermal decomposition-initiating temperature of 200 to 250° C., i.e., in a temperature range of from 250 to 400° C., can be realized by using aramide resin particles having a thermal decomposition-initiating temperature of 400 to 500° C., thus having completed the invention.

That is, the invention has solved the aforesaid problem by the following means:

(1) a friction material containing a fibrous reinforcement, a friction modifier, and a binder as major components, which does not contain asbestos fibers but contains, as an organic friction modifier, para-, meta- and meta-para-type aramide resin dusts independently or as a mixture thereof; and

(2) the friction material as described in (1), wherein the para-type, meta-type and meta-para-type aramide resin dusts are compounded independently or as a mixture thereof in a content of 1 to 60% by volume of the volume of the whole friction material.

### DESCRIPTION OF THE PREFERRED EMBODIMENTS

The mode for carrying out the invention is described below.

The aramide resin dust as an organic dust capable of exhibiting a lubricating effect is outlined below.

It is known that, as shown in Table 1, there are three kinds of para-type, para-meta-type and meta-type aramide resins. These are mainly used in the field of fibers, and hence their material characteristics and properties are described by reference to examples of fibers.

TABLE 1
Kinds of commercially available aramide resins

| | | | Structural |
|---|---|---|---|
| Kind | Trade Name | Compound Name | Formula |
| para- | Kevlar | poly-p-phenylene- | 1 |
| type | (DuPont) | terephthalamide | |
| | Twaron | poly-p-phenylene- | 1 |
| | (Twaron | terephthalamide | |
| | Products) | | |
| meta- | Technola | copoly-p-phenylene-3,4'- | 2 |
| para- | (Teijin) | oxydiphenyleneterephthal- | |
| type | | amide | |
| meta- | Conex | poly-m-phenylene(p- | 4 |
| type | (Teijin) | phenylene) isophthalamide | |
| | Nomex | poly-m-phenylene-isophthal | 3 |
| | (DuPont) | amide | |

4 kinds of chemical structural formulae of these three types of the aramide resins are shown below.

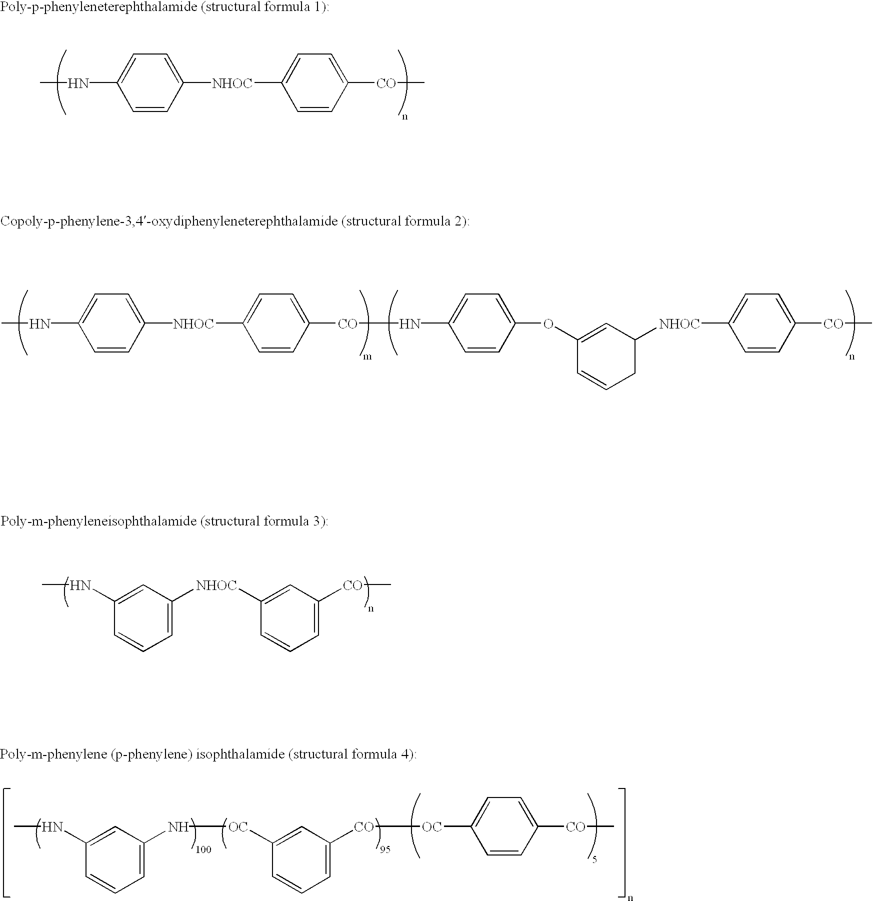

Of the above-described aramide resins, para-type aramide resin gives para-type aramide fibers (PPTA) whose molecular formula is represented by the structural formula 1. A typical example thereof, Kevlar, is a product of DuPont Co., produced by forming into fibers according to a dry-wet spinning method called a liquid crystal-spinning method, and is used for bulletproof vests and safety gloves due to its strong resistance against high-speed deformation.

“Twaron” is an aramide having a similar structure to that of Kevlar and is produced by Twaron Products Co.

Meta-Para Type Aramide Resins:

“Technola” is a fiber made from a meta-para-type aramide resin produced using terephthalic acid chloride derived from petroleum, p-phenylenediamine and, as a third component, a diamine having an ether bond. Its molecular formula is represented by the structural formula 2. It has a solubility improved by copolymerizing the third component in the main chain of Kevlar.

That is, Techlola is a copolymer containing a diamine component about 50 molar % of which is 3,4-diaminodiphenyl ether. It is produced not by the liquid crystal spinning process as with Kevlar but by a process of dry-wet spinning in a common manner, then ultra-stretching it to obtain highly oriented fibers.

Technola has inferior thermal properties than homopolymer PPTA fibers have due to its copolymer structure but, since its molecular chain is somewhat flexible, it has a higher elongation, and is excellent in fatigue resistance, chemical resistance and thermal resistance.

Meta-Type Aramide Resins:

Meta-type aramide resins containing m-pohenylene groups as structural units have a molecular formula represented by the structural formula 3 and, since their molecular structure is bent, they have excellent flameproof properties, heat-resistant properties, weatherability, and chemical resistance, though they are inferior to para-type aramide resins in strength and elastic modulus due to their bent molecular structure.

One of commercially available fibers composed of the meta-type aramide resins, “Nomex”, is a typical meta-type aramide fiber developed by Du Pont Co. in 1960. Main raw materials are m-phenylenediamine and isophthalic acid chloride. Also, “Cone” is produced by Teijin Co., Ltd., and raw materials therefor are m-phenylenediamine and isophthalic acid chloride. The polymer is produced by condensation polymerization with eliminating hydrochloric acid, and is being used as a substitute for asbestos or for fiberglass reinforced plastics (FRP).

As the aramide resin dust, those which have an average particle size of 10 to 2000 microns, preferably 30 to 500 microns, may be used. The amount of aramide resin dust compounded as an organic friction modifier in a friction material maybe 1 to 60% by volume, preferably 2 to 20% by volume. However, in case where compounded in an amount of less than 1% by volume, the aramide resin dust fails to provide desired effects. On the other hand, in case where the aramide resin dust is compounded in an amount of more than 60% by volume, there occurs a phenomenon of fade at an elevated temperature, thus such amount not being preferred.

The friction material of the invention can be produced in the same manner as with a friction material produced from major raw materials of a fibrous reinforcement, a friction modifier and a binder by mixing the raw materials, preforming the mixture in a common manner, and heat-forming the preform.

In the above description, the fibrous reinforcement includes, for example, organic fibers such as aromatic polyamide fibers and flame-resistant acrylic fibers; metal fibers such as copper fibers and steel fibers; and inorganic fibers such as potassium titanate fibers and Al₂O₃—SiO₂-based ceramic fibers.

Examples of the inorganic filler include particles of metals such as copper, aluminum or zinc, flake-like inorganic substances such as vermiculite and mica, and particles of barium sulfate or calcium carbonate.

Examples of the binder include phenol resins (inclusive of straight phenol resin, and various kinds of phenol resins modified by rubber), melamine resin, epoxy resin and polyimide resin.

Examples of the friction modifier include, in addition to the aforesaid aramide resin powder of the invention, metal oxides such as alumina, magnesia, zirconia, chromium oxide and quartz, and other organic friction modifiers. Examples of the solid lubricant include graphite and molybdenum disulfide. However, as the organic friction modifier, independent use of the aramide resin powder is preferred.

As a formulation of the friction material, there may be employed various formulations.

That is, the components may be used alone or in combination of two or more depending upon the friction properties required for the end product, such as coefficient of friction, wear resistance, vibration properties, noise, etc.

Fundamental formulation ranges of the friction material of the invention are shown in Table 2. Other friction material-constituting substances may also be mixed by changing the mixing ratio within amounts of the preferred ranges shown in Table 2.

TABLE 2
Fundamental Mixture of Friction Material

| | Preferred Range |
|---|---|
| Component | (% by Volume) |
| Phenol resin | 8-22 |
| Ceramic fiber | 1.5-4.5 |
| Aramid fiber (para-type aramid pulp) | 2-7 |
| Copper fiber | 1-4 |
| Inorganic friction modifier | 15-50 |
| (barium sulfate) | |
| Organic friction modifier | 1-60 |
| (aramide resin dust) | |
| Lubricant (graphite) | 5-20 |

A process for producing a brake pad for disc brake involves a heat-molding step of heat-molding a pressure plate formed into a predetermined shape by pressing a sheet metal, subjecting it to degreasing treatment and primer processing, and applying thereto an adhesive agent and a preform formed by mixing a fibrous reinforcement such as heat-resistant organic fibers or metal fibers with an inorganic or organic filler, a friction modifier and a binder, well homogenizing through stirring, and forming the raw material mixture at an ordinary temperature under a predetermined pressure (preforming), at a predetermined temperature and under a predetermined pressure to thereby interlock and unify the pressure plate and the preform, conducting aftercure, and finally conducting finishing treatment, with the steps before this step being the same as in the conventional process.

### EXAMPLES

The invention is described more specifically by reference to Examples which, however, do not limit the invention in any way.

### Examples 1 to 7 and Comparative Example

In Examples, commercially available Kevlar resin dust, Conex resin dust, and a Technola resin dust prepared in the following manner were used.

(Process for Preparing Technola Resin Dust)

A dope for spinning fibers containing Technola resin (solvent; N-methylpyrrolidone) prepared according to the process described in Japanese Patent Laid-Open Sho 52-098795 was dropwise added into water, and the resultant precipitate of resin particles was desolvated, washed with water and dried to obtain particulate Technola resin.

(Mixture of a Friction Material)

Fundamental mixture of the friction material used in Examples is shown in Table 3.

TABLE 3
Mixture of Friction Material of the Examples

| | Mixed Amount |
|---|---|
| Component | (% by volume) |
| Phenol resin | 20 |
| Ceramic fibers | 4 |
| Aramide fibers (para-type aramide pulp) | 6 |
| Copper fibers | 3 |
| Inorganic friction modifier (barium dust) | 42 |
| Organic friction modifier | 10 |
| (aramide resin dust) | |
| Lubiricant (graphite) | 15 |

As the aramide fibers, pulp-like para-type aramide, Kevlar (trade name), was used. As the aramide fibers, those fibers which are shown in Table 1 may be used as well as that used in the Examples. As the aramide resin dust used as an organic friction modifier, m-type, meta-para-type and para-type ones may be used alone or in combination of two or three. In the Examples, aramide resin dusts of 380 microns in average particle size were used in a total amount of 10% by volume, but the average particle size and the mixing amount may properly be changed depending upon the aimed objects.

In a comparative example, cashew dust of 380 microns in average particle size was added in an amount of 10% by volume as the organic friction modifier in place of the aramide resin dust.

(Preparation of Friction Materials for Test)

Brake pads for disc brakes were prepared in a conventional manner according to the above-described mixing conditions. However, the Examples show only examples, and there are no limitations as to mixing ratios of meta-, meta-para-, and para-type aramides.

(Wear Test)

Wear test was conducted at 200, 250, 300 and 400° C. using a dynamotester according to the wear test items on a passenger car and the testing method provided by Japanese Automotive Standard.

Results obtained by adding each type aramide resin dust independently and results of the comparative example obtained by adding cashew dust are shown in Table 4, and results obtained by adding a mixture of individual types of the aramide resin dusts are shown in Table 5.

It is seen from the results shown in Tables 4 and 5 that, in comparison with the comparative example, wear properties were remarkably improved in the Examples at 250 to 400 C.

TABLE 4
Independent Use

| | | | | | Comparative |
|---|---|---|---|---|---|
| Example | | 1 | 2 | 3 | Example |
| Resin (resin dust) | | m | p | mp | C |
| Wear Ratio | 200° C. | 0.17 | 0.17 | 0.17 | 0.17 |
| (× 10⁻⁴ mm³/Nm) | 250° C. | 0.18 | 0.18 | 0.19 | 0.22 |
| | 300° C. | 0.32 | 0.36 | 0.35 | 0.70 |
| | 400° C. | 1.17 | 1.25 | 1.20 | 1.88 |

m: meta-type aramide
p: para-type aramide
mp: meta-para-type aramide
C: cashew dust

TABLE 5
Composite Use

| Example | | 4 | 5 | 6 | 7 |
|---|---|---|---|---|---|
| Resin (resin dust) | | m + p | mp + p | mp + m | m + p + mp |
| mixing ratio = 1:1 (:1) | | | | | |
| Wear Ratio | 200° C. | 0.17 | 0.17 | 0.17 | 0.17 |
| (× 10⁻⁴ mm³/Nm) | 250° C. | 0.19 | 0.19 | 0.18 | 0.18 |
| | 300° C. | 0.33 | 0.35 | 0.33 | 0.33 |
| | 400° C. | 1.19 | 1.23 | 1.18 | 1.18 |

m: meta-type aramide
p: para-type aramide
mp: meta-para-type aramide

The friction material of the invention can markedly improve the lubricating effect of a friction material in a temperature range of from 250 to 400° C. by using para-type, meta-para-type and meta-type aramide resin dusts as an organic friction modifier solely or in combination to thereby supplement the poor lubricating effect of cashew dust at an elevated temperature.

The friction material of the invention shows a less wear ratio, better wear resistance, and longer life than conventional friction materials wherein cashew dust is used as an organic friction modifier.

What is claimed is:

1. A friction material containing a fibrous reinforcement, a friction modifier, and a binder as major components, further containing
at least one member as an organic friction modifier chosen from a group of para-type aramide resin dusts, meta-type aramide resin dusts and meta-para-type aramide resin dusts.

2. A friction material according to claim 1, the friction material contains at least two organic friction modifiers as a mixture.

3. A friction material according to claim 2, characterized by that said organic friction modifiers are aramide resin dusts.

4. A friction material according to claim 3, further characterized by that said organic friction modifiers are members chosen from a group of para-type aramide resin dusts, meta-type aramide resin dusts and meta-para-type aramide resin dusts.

5. The friction material as described in claim 1, wherein the para-type, meta-type and meta-para-type aramide resin dusts are compounded thereof in a content of 1 to 60% by volume of the whole friction material.

6. The friction material as described in claim 2, wherein the para-type, meta-type and meta-para-type aramide resin dusts are compounded thereof in a content of 1 to 60% by volume of the whole friction material.

7. A friction material according to claim 1, wherein the friction material does not contain asbestos fibers.
